(19) United States
(12) Patent Application Publication
(10) Pub. No.: US 2025/0223993 A1
(43) Pub. Date: Jul. 10, 2025

(54) MULTI-SUBSTRATE FASTENER

(71) Applicant: Pegasus Solar Inc, Richmond, CA (US)

(72) Inventors: Erich Kai Stephan, Richmond, CA (US); Ian Wogan, Richmond, CA (US); Ian Lennox, Richmond, CA (US)

(21) Appl. No.: 19/009,845

(22) Filed: Jan. 3, 2025

Related U.S. Application Data
(60) Provisional application No. 63/617,764, filed on Jan. 4, 2024.

(51) Int. Cl. F16B 35/04

(52) U.S. Cl. CPC F16B 35/041

(57) ABSTRACT

A threaded fastener for securing a plate to a layered substrate is provided, as well as methods for installing the threaded fastener. An exemplary threaded fastener may include a head, and a shank having a longitudinal axis between a first end and a second end. The shank may be connected to the head at the second end. The shank may have a pointed terminus at the first end. The shank may have a first portion between the first end and a transition region. The first portion may include a first thread having a first thread profile that encircles the first portion. The shank may have a second portion between the transition region and the second end. The transition region may reside between the first portion and the second portion. The second portion may include a second thread having a second thread profile that encircles the second portion.

### CROSS-REFERENCES TO RELATED APPLICATION

The present application claims the priority benefit of U.S. Provisional Patent Application No. 63/617,764 filed on Jan. 4, 2024, the disclosure of which is incorporated herein by reference in its entirety.

### BACKGROUND

Current fasteners typically have one thread profile designed to secure an object to a single substrate. In many instances, it may be desired to secure a fastener to a second substrate obstructed from view by the first substrate. Current fasteners may be best configured to secure into either a first or a second type of substrate, but not both. The present invention, in certain embodiments, is a fastener that is designed to secure into a second substrate if the second substrate is positioned directly below, and up against, the first substrate. The fastener in these embodiments has two thread profiles, the first of which is suited for the first substrate whether or not the fastener is also to be installed into the second substrate, and the second thread profile is suited for the second substrate. The invention also extends to fasteners with a single thread profile.

### SUMMARY OF THE CLAIMED INVENTION

Embodiments of the present technology include a threaded fastener for securing a plate to a layered substrate, as well as methods for securing the plate to the layered substrate. An exemplary threaded fastener may include a head, and a shank having a longitudinal axis between a first end and a second end. The shank may be connected to the head at the second end. The shank may have a pointed terminus at the first end. The shank may have a first portion between the first end and a transition region. The first portion may include a first thread having a first thread profile that encircles the first portion. The shank may have a second portion between the transition region and the second end. The transition region may reside between the first portion and the second portion. The second portion may include a second thread having a second thread profile that encircles the second portion.

In some examples, a method for securing the plate to the layered substrate includes positioning the plate on the layered substrate that includes at least a first layer and a second layer. The plate is positioned adjacent to the second layer so that the second layer is between the first layer and the plate. The method includes aligning a threaded fastener with an aperture in the plate. The threaded fastener including a shank having a first thread and a second thread. The method includes installing the threaded fastener through the aperture and into the layered substrate such that a first portion of the shank corresponding to the first thread extends into the first layer and a second portion of the shank corresponding to the second thread extends into the second layer.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIGS. 1A-B depict a side view and a perspective view of an exemplary fastener.

FIG. 2A depicts a side view of an exemplary fastener and a deck thread sleeve in an assembled state.

FIG. 2B depicts a close-up view of the upper end of an exemplary fastener with a deck thread sleeve partially positioned over the shank.

FIGS. 2C-D depict a side view and a perspective view of an exemplary fastener and a deck thread sleeve in a disassembled state.

FIGS. 3A-C depict side views of one or more fasteners installed to secure a mount to an installation surface, the side views being in partial cutaway.

FIGS. 4A-C depict a side view, a perspective view, and an underside perspective view of an exemplary deck fastener.

FIGS. 5A-B depict perspective views of an exemplary hook mount 410 with two deck fasteners 400.

FIGS. 6A-D depict an isometric view, a side view, and end views of an exemplary hook mount fastened to an installation surface to one or more substrates using two deck fasteners.

FIGS. 7A-B depict a side view and a cross-sectional view of another exemplary fastener.

FIG. 8A depicts a side view of an alternative exemplary embodiment of a fastener with a distal end.

FIG. 8B depicts a close-up view of the distal end of an exemplary fastener.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

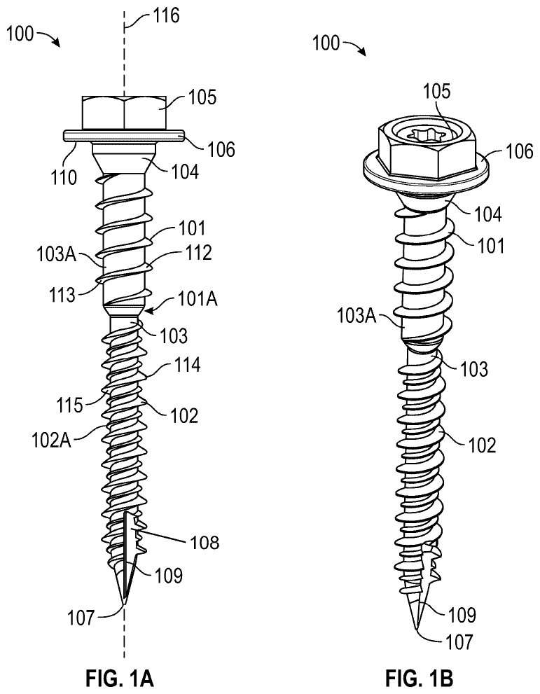

FIGS. 1A-B depict a side view and a perspective view of an exemplary fastener 100. The fastener 100 has a shank 103 (e.g., a shaft) with a longitudinal axis 116, a head 105 that may be disposed at a second end (e.g., one distal end) of the shank 103, and a sharp terminus (e.g., sharp fastener tip 107) disposed at the first end (e.g., distal end opposite from the one distal end) of the shank 103. In some examples, the distal ends (e.g., the first end and the second end) are disposed along the longitudinal axis 116. Connecting the shank 103 to the head 105 may be a shoulder 104, the diameter of which may be greater than the diameter of the shank 103 and less than the diameter of the head 105. Disposed on the shank 103 may be a deck thread 101 and a primary rafter thread 102. In some examples, the primary rafter thread 102 is disposed on a first portion of the shank 103, and the first portion resides between a transition region 101A and the opposite distal end (e.g., a first end). In similar examples, the deck thread 101 is disposed on a second portion of the shank 103, and the second portion resides between the transition region 101A and distal end (e.g., a second end) of the shank 103. In some examples, the first portion has a first shank diameter and the second portion has a second shank diameter. In some examples, the first shank diameter is smaller than the second shank diameter. Certain embodiments of the invention may also have an additional, third thread (e.g., secondary rafter thread(s) 102A) having a third thread profile encircling the first portion, whose diameter is less than the first thread (e.g., the primary rafter thread 102), with the first and third threads alternating along the length of the first portion (e.g., rafter portion) of the shank. The deck thread 101 may be located on the shank 103 between the rafter portion having the primary rafter thread(s) 102 and secondary rafter thread(s) 102A), and the head 105.

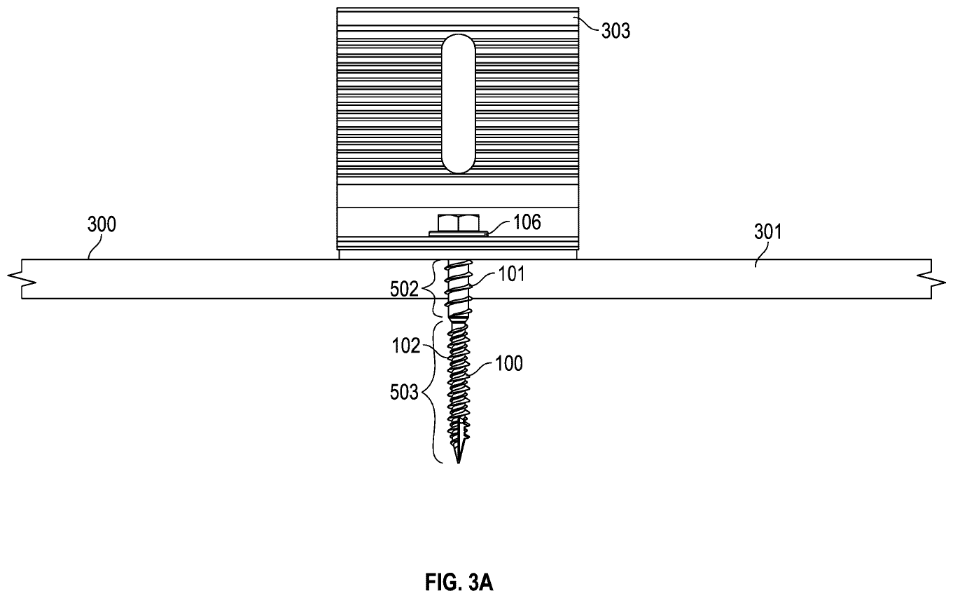

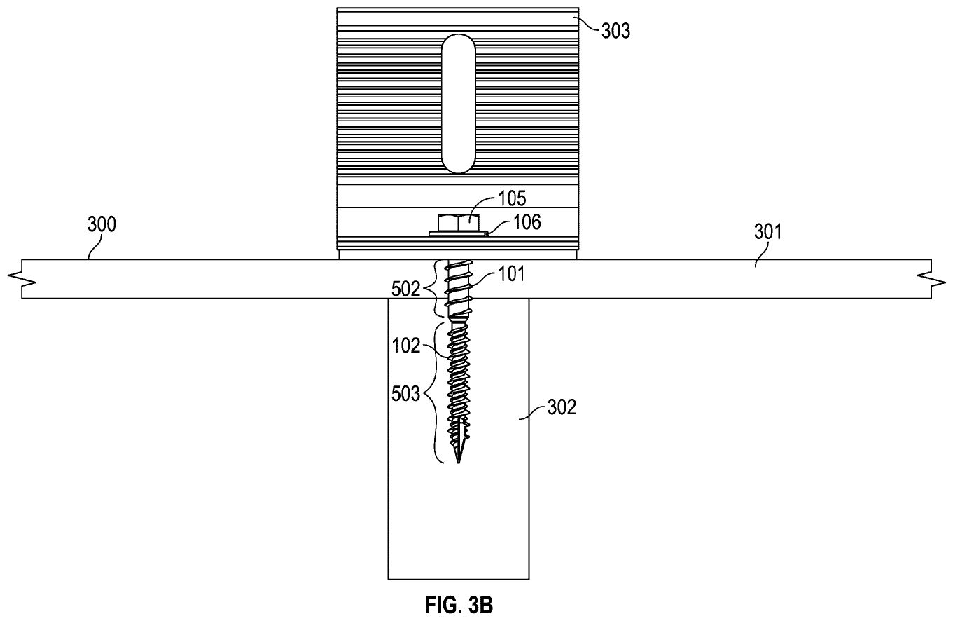

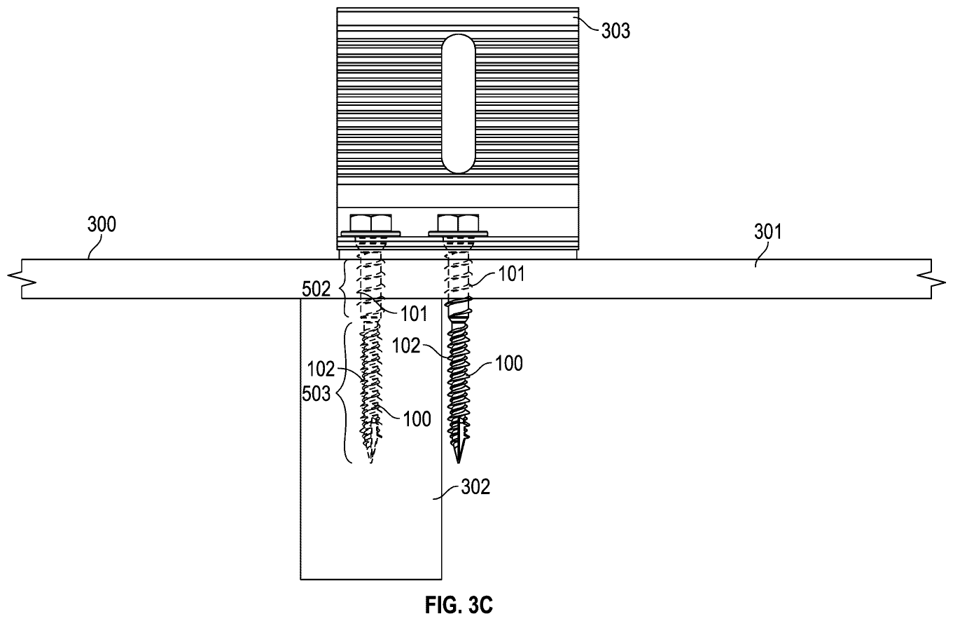

In some examples, the second thread (e.g., the deck thread 101) and first and third threads (e.g., the primary rafter thread 102 and the secondary rafter thread 102A) may have different thread profiles. For example, the first thread has a first thread profile, the second thread has a second thread profile, and the third thread has a third thread profile. In some examples, a second thread profile (e.g., profile of the deck thread 101) encircles the second portion of the shank 103, and a first thread profile (e.g., profile of the primary rafter thread 102) encircles the first portion of the shank 103. In some examples, each thread profile has a corresponding thread major diameter. For example, the third thread profile has a third thread major diameter and the first thread profile has a first thread major diameter, and the third thread major diameter is smaller than the first thread major diameter of the first thread profile. In an exemplary embodiment, the deck thread 101 and at least the primary rafter thread 102 being separated by a transition region 101A. The deck thread 101 may for example have a diameter larger than that of the rafter thread 102 and configured to threadedly engage with a material such as plywood, oriented strand board, particle board, sheetrock, foam, and other similar materials with similar material hardness. In some examples, the deck thread 101 may also have fewer threads per length along the shank 103 compared to the rafter thread 102. The deck thread 101 may thus be configured to engage in a substrate with a relatively low material hardness, while the rafter thread 102 may be configured to engage in a substrate with a relatively high material hardness. In some examples of installation surfaces, such as those shown in FIGS. 3A and 3B, an oriented strand board may serve as the first substrate 301 and a solid wood beam may serve as the second substrate 302. The deck thread 101 may be configured to threadedly engage with all or a majority of the first substrate 301, and the rafter thread 102 may be configured to engage with all or a majority of the second substrate 302.

In some examples, the deck thread 101 may have an asymmetric triangular or trapezoidal cross-sectional shape as depicted, where the deck upper thread face 112 that faces the head 105 forms a larger angle with longitudinal axis 116 than the deck lower thread face 113 that faces the fastener tip 107. For example, deck upper thread face 112 may be at an angle with longitudinal axis 116 between 100 to 140 degrees, and the deck lower thread face 113 may be at an angle with longitudinal axis 116 between 90 to 120 degrees. In other example embodiments, the deck thread 101 may have a symmetric thread profile wherein both thread faces form an equal or substantially equal angle relative longitudinal axis 116, such an angle between 100 to 140 degrees. The rafter thread 102 may have an asymmetric triangular or trapezoidal cross-section as depicted, where the rafter upper thread face 114 that faces the head 105 forms a larger angle with longitudinal axis 116 than the rafter lower thread face 115 that faces the fastener tip 107. For example, rafter upper thread face 114 may be at an angle with longitudinal axis 116 between 100 to 140 degrees, and the rafter lower thread face 115 may be at an angle with longitudinal axis 116 between 90 to 120 degrees. In other example embodiments, the rafter thread 102 may have a symmetric thread profile wherein both thread faces form the same or substantially the same a similar angle relative to longitudinal axis 116, such an angle between 100 to 140 degrees.

In some examples, the rafter thread 102 may converge with the deck thread 101 in a continuous manner by variably angling or sloping the thread at the transition region 101A to form a discontinuity at a point in that region. In other words, the helical path of the rafter thread 102 and deck thread 101 may be substantially similar (e.g., aligned) even if there is a break in the material of the two respective threads. In this way, as the rafter thread 102 is installed through a material (e.g., wood), the deck thread 101 may enter the material at the cut-out created by the rafter thread. In an example where the material is wood, when the rafter thread engages and cut a path in the wood, the deck thread 101 engages that same path, tunnel, or cut out created by the rafter thread 102 as the tail of the rafter thread keeps going further into the wood. This way, the wood fibers surrounding the cut out or tunnel are not disturbed, thereby allowing the deck thread 101 to not engage more wood fibers. In other example embodiments, the rafter thread 102 and the deck thread 101 may each terminate at the transition, with distinct start and stop profiles, faces, or edges, thereby leaving a gap at between the two threads at the transition region 101A. The transition region 101A can either be a point along the longitudinal axis 116 forming an abrupt transition, or a frustoconical section of the shank tapering from the second shank diameter to the first shank diameter as shown in FIG. 1A.

In some examples, the outer diameter, or a second thread major diameter (e.g., major diameter of deck threads 101), may be 7 to 12 millimeters, and a second shank diameter (e.g., the diameter of deck shank 103A), or the minor diameter of the deck thread 101, may be 5 to 8 millimeters. The ratio between the major and minor diameter of the deck thread 101 may be between 1.3:1.0 to 1.6:1.0. Similarly, the outer diameter, or a first thread major diameter (e.g., major diameter of rafter thread 102), may be 3 to 5 millimeters, and a first shank diameter (e.g., the diameter of shank 103) under the rafter threads 102, or the minor diameter of the rafter thread 102, may be 5 to 8 millimeters. The ratio between the major and minor diameter of the rafter thread 102 may be between 1.6:1.0 to 1.8:1.0. In some examples, the ratio between the second thread major diameter (e.g., major diameter of the deck thread 101) and the first thread major diameter (e.g., major diameter of the rafter thread 102) may be between 1.1:1.0 to 1.4:1.0. In some examples, the first thread major diameter is smaller than the second thread major diameter.

In example embodiments where a secondary rafter thread 102A exists, the secondary rafter thread 102A may have an outer, or major, diameter of 5 to 7 millimeters. The ratio between the major diameters of rafter thread 102 and secondary rafter thread 102A may be between 1.1:1.0 to 1.25:1.0.

A part line plane 108 may bisect the fastener 100 along a mid-plane that includes the longitudinal axis 116. In such embodiments, the top surface of the head 105 may be at a non-perpendicular angle to the part line plane 108. Many or all surfaces on the deck thread 101 and the rafter thread 102 may likewise form a non-perpendicular angle to the part line plane 108.

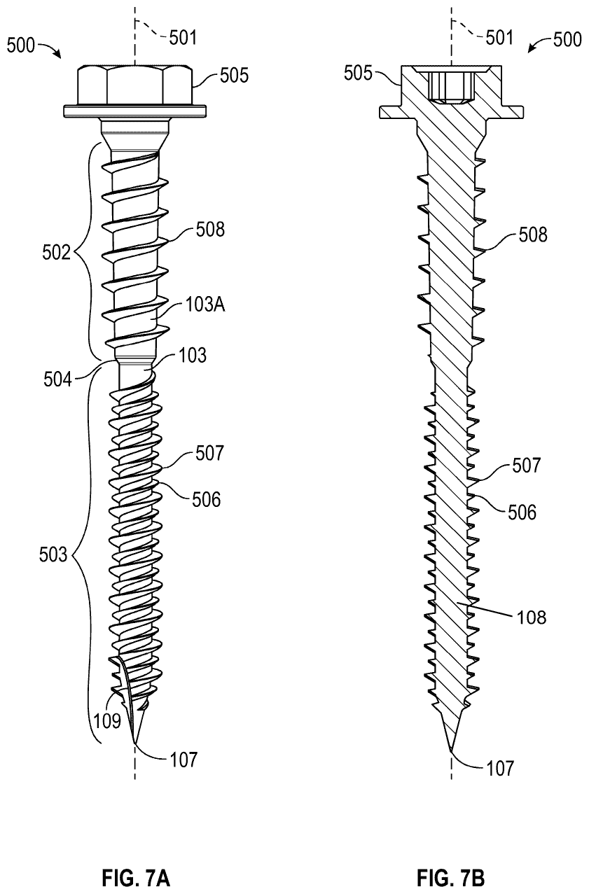

In some examples, shank 103 may be cylindrical in shape along the majority of its length and taper to a point at the fastener tip 107, as shown in FIGS. 1A and 1B. In other example embodiments, the shank 103 may taper along all or a portion of its length along the longitudinal axis 116 from the second end to the first end, as shown in FIGS. 7A and 7B with the deck shank 103A, discussed further below. In either case, the shaft may taper further at a sharper angle, towards the fastener tip 107 at the bottom end of the shaft. The fastener tip 107 may also be configured with a cutting edge tip 109 at the end of, and along the shank adjacent to the first end (e.g., fastener tip 107) to cut or tap into a substrate material such as metal or wood.

Referring again to FIGS. 1A and 1B, the fastener 100 may have a shoulder 104 and a head flange (e.g., flange 106) between the second portion (e.g., upper end) of the shank 103 and the head 105 at the top of the shank 103. In some examples, the flange 106 can be circular and symmetrically disposed around the longitudinal axis 116. In other examples, the diameter of the flange 106 can exceed the width of the head 105, and the major diameters of both profiles of the second thread (e.g., deck thread 101) and the first thread (e.g., rafter thread 102). In other example embodiments not shown, the fastener 100 may have neither a shoulder 104 nor a flange 106, and the shank 103 may directly connect to the head 105.

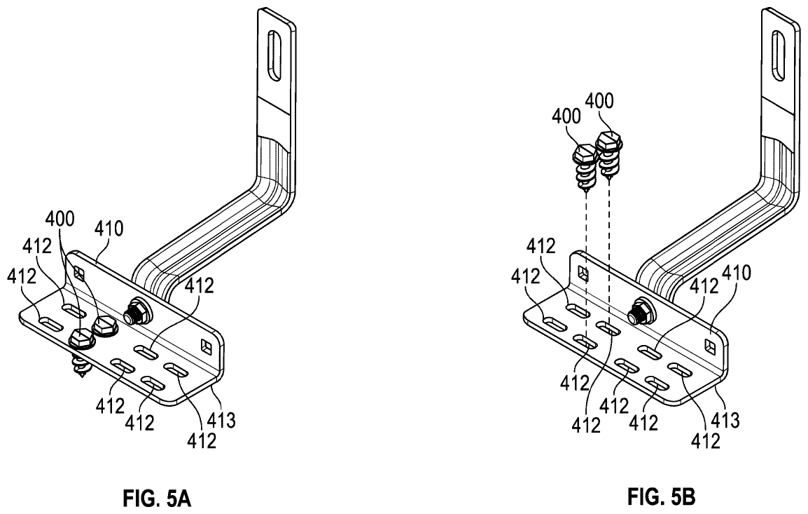

In some examples, the cutting edge tip 109 when included can be configured to cut or pierce through a thin layer of material on a mount 303 (as shown in FIGS. 3A and 3B), or a mount plate 413 (as shown in FIGS. 5A and 5B). In some examples, the mount 303 or mount plate 413 may be made of die-cast aluminum, a zinc alloy, steel, coated steel, or a polymer, or other suitable material.

In some examples, the fastener 100 may be formed of steel, stainless-steel, aluminum, a polymer, or other suitable material. In some examples, the fastener 100 including the second thread (e.g., the deck thread 101) and the first thread (e.g., rafter thread 102) may be formed in a thread-rolling process, die-cast process, investment casting, or other suitable manufacturing process. In some examples, an anti-corrosion coating (e.g., corrosion resistant coating) may be disposed on all surfaces of fastener 100. In some examples, the fastener 100 has a part line along a longitudinal axis 116 of the shank. In some examples, the upper surface of the head 105 may have two sections that are sloped downward from the longitudinal axis in opposite directions from the part line.

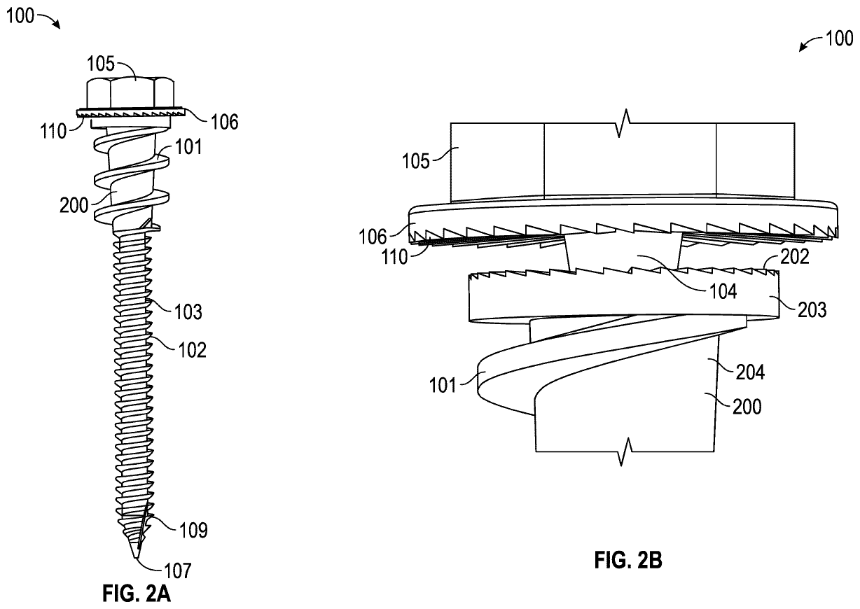

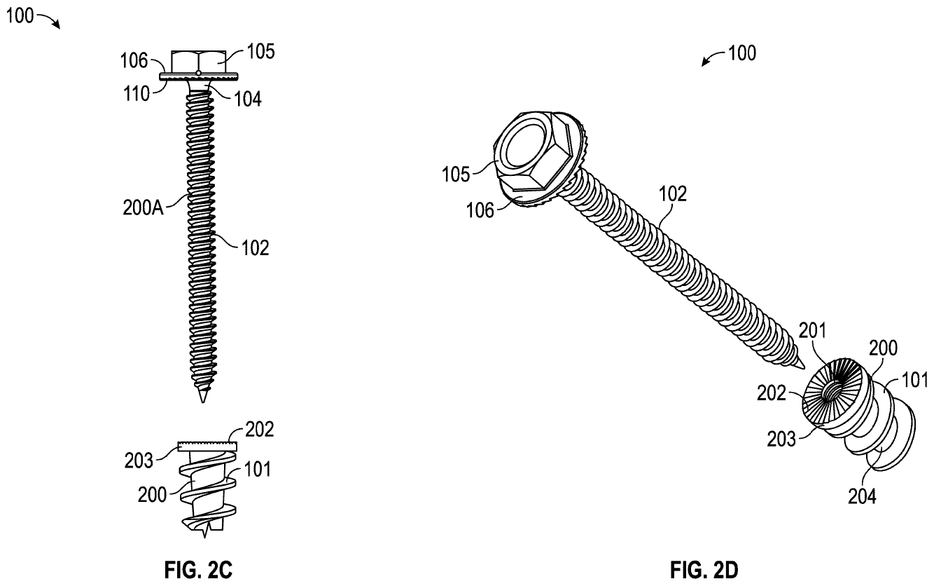

FIG. 2A depicts a side view of an exemplary fastener 100 and a deck thread sleeve 200 in an assembled state. In this illustrative example, the deck thread 101 is formed on a deck thread sleeve 200, which is a component separate from the shank 103 but configured to fit over an inner shank 200A. In some exemplary embodiments, the first portion comprises the inner shank 200A. For example, the inner shank 200A can simply be an upper extension of the rafter portion of the fastener 100. In such an example, the diameter of the inner shank 200A is identical to the diameter of the first portion. The inner shank 200A will thus have a thread profile identical to, and/or a continuation of the first thread (e.g., rafter thread 102).

In some examples, the deck thread sleeve 200 may be coupled to the shank 103 either at a short distance from or fully coincident with the flange 106, the head 105, or the shoulder 104. The diameter of the deck thread 101 may be wider than the of the rafter thread 102. The deck thread 101 may also have a variable diameter, such as tri-lobular, or a diameter that increases along the length of the deck thread sleeve 200, such as tapered helical threads. In some examples, the deck thread sleeve 200 is adapted to fit over the inner shank 200A, engaging with the first thread encircling the inner shank 200A. In such examples, the deck thread sleeve 200 has a hollow interior with internal threads 201 (as illustrated in FIG. 2D) that are configured to mate (e.g., threadedly engage) with the first thread (e.g., rafter thread 102) encircling the inner shank 200A, or with another thread profile disposed on the shank 103 between the rafter thread 102 and the head 105. In some examples, the deck thread sleeve 200 may have a sleeve flange 203 at one end, and a series of sleeve serrations 202 on an exterior surface of the sleeve flange 203 orthogonal to the longitudinal axis of the deck thread sleeve 200 (as illustrated at least in FIG. 2B).

FIG. 2B depicts a close-up view of the upper end of an exemplary fastener 100 with a deck thread sleeve 200 partially positioned over the shank 103 before the sleeve flange 203 contacts the flange 106. In some examples, the sleeve flange serrations 202 are arranged to oppose to mate with the serrations on the head flange when the deck thread sleeve 200 is installed over the inner shank 200A, thus preventing rotation of the deck thread sleeve 200 relative the inner shank 200A during removal of the fastener 100 from the layered substrate. For example (as shown in FIG. 2B), serrations 110 on the head flange (e.g., flange 106) may be configured to slope in a clockwise direction and configured to engage with sleeve serrations 202 on the deck thread sleeve 200 which are sloped in an opposite, counterclockwise direction. The sleeve serrations 202 will thus engage with the serrations 110 so that the sharp surfaces of the corresponding serrations mate with each other to prevent the deck thread sleeve 200 from readily de-threading from the shank 103 when the fastener 100 is being turned in a counterclockwise direction, such as during removal of the fastener from an installation surface 300 (as shown at least in FIG. 3A). The sleeve serrations 202 may thus be angled to slope in a direction opposite to that of the slope of the deck thread 101. When the deck thread sleeve 200 is coupled to the shank 103, the slopes of the serrations 110 and the sleeve serrations 202 may be substantially parallel, as depicted. The sleeve serrations 202 and the serrations 110 may each be a plurality in number as shown or may only be a single serration each.

FIGS. 2C-D depict a side view and a perspective view of an exemplary fastener 100 and a deck thread sleeve 200 in a disassembled state. To assemble, the deck thread sleeve 200 may be threaded onto the shank 103 to a specific torque value, wherein that assembly torque value is greater than the torque value to unthread the assembled fastener 100 from both the first substrate 301 and second substrate 302 in which the fastener is installed (as shown at least in FIG. 3B). The deck thread sleeve 200 can be locked onto the fastener 100 by the use of a protrusion on the deck thread sleeve 200 configured to engage with an impression on the fastener 100.

In some examples, the deck thread sleeve 200 may be made from an aluminum alloy, a zinc alloy, steel, a polymer, or any similar material. In some examples, the deck thread sleeve 200 may be coated with a non-corrosive coating, or it may be uncoated. The deck thread sleeve 200 may be manufactured with processes including roll formed, die cast, investment cast, or similar manufacturing processes.

FIGS. 3A-C depict side views of one or more fasteners 100 installed to secure a mount 303 to an installation surface 300, the side views being in partial cutaway.

As illustrated in FIG. 3A, the installation surface 300 may comprise a single substrate (e.g., first substrate 301), which may be, for example, plywood or oriented strand board with one or more layers of composition asphalt shingles on top. In some examples, the installation surface 300 may comprise one or more layers of substrates having at least a first layer of the layered substrate and a second layer of the layered substrate. In some examples, the first layer has a first material hardness and the second layer has a second material hardness. For example, the first layer of the layered substrate (e.g., first substrate 301) may be any material typical of installation surfaces 300, such as sheetrock or plasterboard, with different material hardnesses. In some examples, the first material hardness is greater than the second material hardness.

In some examples, a method for installing the fastener 100 includes installing the fastener 100 through an aperture in the top surface of the mount 303. The aperture may have an opening that is of larger diameter than the diameter of the deck thread 101 to allow the deck thread 101 to pass through, but smaller than the diameter of the flange 106 so that the flange 106 can secure the mount 303 to the installation surface 300. The deck thread 101 may extend below the bottom surface of the mount 303 and partially or fully through the thickness of the first substrate 301.

FIG. 3B depicts an example alternative installation configuration wherein the installation surface 300 has both a first substrate 301 and a second substrate 302, with the second substrate 302 disposed underneath the first substrate 301. The deck thread 101 may extend partially or fully through the first substrate 301 as shown, and may or may not extend into second substrate 302. The rafter thread 102 is configured to extend into the second substrate 302 and may or may not reside within the first substrate 301 once the fastener 100 is fully installed.

FIG. 3C depicts another example alternative installation configuration wherein the mount 303 is secured to the installation surface 300 with two fasteners 100. In this example embodiment, the mount 303 may have an aperture of extended length such as a slot, to accept both fasteners 100, or two or more apertures, each configured to accept or receive a separate fastener 100. In the example shown, the first fastener 100 is installed into a first aperture disposed in the mount 303 in a location offset or to the side of the second substrate 302. The deck thread 101 of the first fastener 100 is secured into the first substrate 301, but the rafter thread 102 of that fastener is not installed into any solid substrate. The second fastener 100 is then installed laterally to the first fastener 100 such that the second fastener 100 is positioned over the second substrate 302. The deck thread 101 of the second fastener 100 is installed into the first substrate 301 and the rafter thread 102 is installed into the second substrate 302.

In an example of an installation sequence or method for installing the fastener 100 to an installation surface 300, the mount 303 may first be placed upon the installation surface 300. The fastener 100 (e.g., a first fastener) is then disposed on the mount 303 and placed in an aperture (e.g., a first aperture) in a plate and into the layered substrate such that the first portion of the shank extends to a first layer of the layered substrate (e.g., first substrate 301) and a second portion of the shank extends to a second layer of the layered substrate (e.g., the second substrate 302). In some examples, the second layer of the layered substrate resides between the first layer and the plate. The second fastener 100 is then placed in a second aperture disposed laterally from the first aperture so that the second fastener 100 is installed into the first substrate 301 only and not into the second substrate 302 (as illustrated in FIG. 3C).

In another example of an installation sequence, the mount 303 may first be positioned onto the installation surface 300. The first fastener 100 may be installed through a first aperture in the mount 303 and into the first substrate 301. If the first fastener 100 is installed into the second substrate 302, the second fastener 100 may be installed into the second aperture which is also positioned over the second substrate 302. If the first fastener 100 is installed into the first substrate 301 only and not into the second substrate 302, then a second fastener 100 may be installed into a third aperture positioned laterally over the second substrate 302 so that the second fastener 100 is installed into both the first substrate 301 and the second substrate 302 (as illustrated in FIG. 3C). A third fastener 100 may then be installed into a fourth aperture disposed over second substrate 302. In this example, the second aperture may remain vacant.

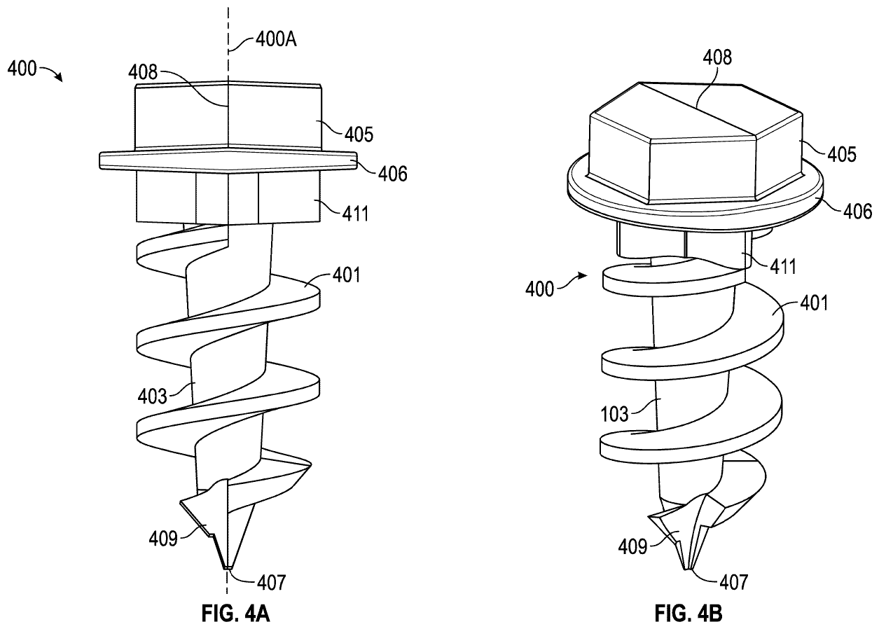

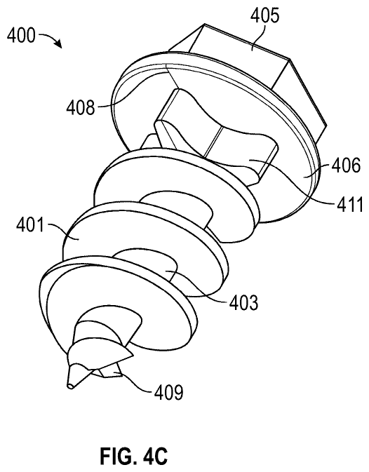

FIGS. 4A-C depict a side view, a perspective view, and an underside perspective view of an exemplary deck fastener 400. In some examples, the deck fastener thread 401 is the only thread of the deck fastener 400. The deck fastener thread 401 may have a uniform diameter for a portion of its length, or it may have a variable diameter along the longitudinal axis 400A of the deck fastener 400. A lobed shoulder 411 may reside between the deck fastener thread 401 and the deck fastener flange 406. The lobed shoulder 411 may have a circular shape or a multi-lobular shape as depicted. The diameter of the exterior circle defined by the distal edges of the lobes of the lobed shoulder 411 may be equal in diameter to or different in diameter from the diameter of the deck fastener thread 401. The exterior diameter may also be of lesser diameter than the diameter of the aperture on the mount to allow the deck fastener 400 to freely rotate within the aperture. The deck fastener 400 may have a tapered end 407 and a cutting edge 409 similar to the exemplary embodiments illustrated in the above figures.

In some examples, the deck fastener 400 can be cast from any of the materials listed above by any of the casting methods listed above, with a part line 408 at the plane that bisects the deck fastener 400 along the longitudinal axis 400A of the deck fastener 400. The upper surface of the deck fastener head 405 may have two sections that are sloped downward from the longitudinal axis in opposite directions from the part line 408 to facilitate the parting of the cast fastener from its parting mold.

FIGS. 5A-B depict perspective views of an exemplary hook mount 410 with two deck fasteners 400. The hook mount 410 may have one or more mount apertures 412 in its mount plate 413. In some examples, the mount apertures 412 may be circular in shape or slotted as depicted. The widths of these mount apertures 412 may be selected to allow the deck fastener threads 401 and the lobed shoulders 411 of the deck fasteners 400 to pass through while preventing the deck fastener flange 406 from passing through. In some examples, the lobed shoulder 411 may extend along the length of the deck fastener shank 403 of each fastener by a distance equal to or less than the thickness of the mount plate 413 such that the lobed shoulder 411 does not protrude below the lower surface of the mount plate 413 when the deck fasteners 400 are fully installed in the hook mount 410.

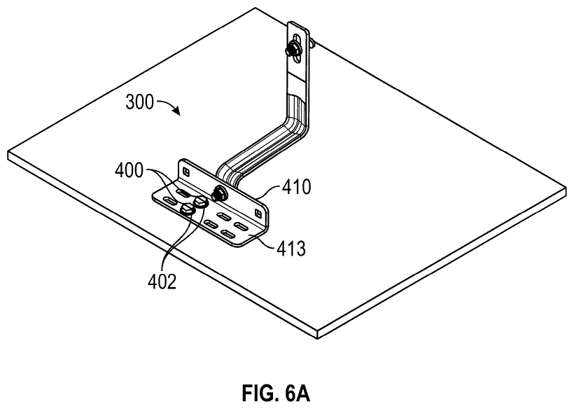

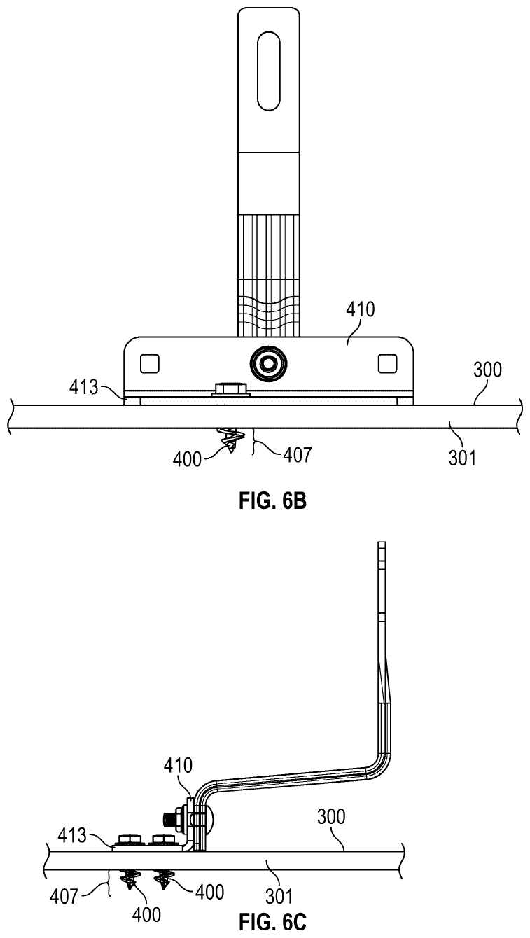

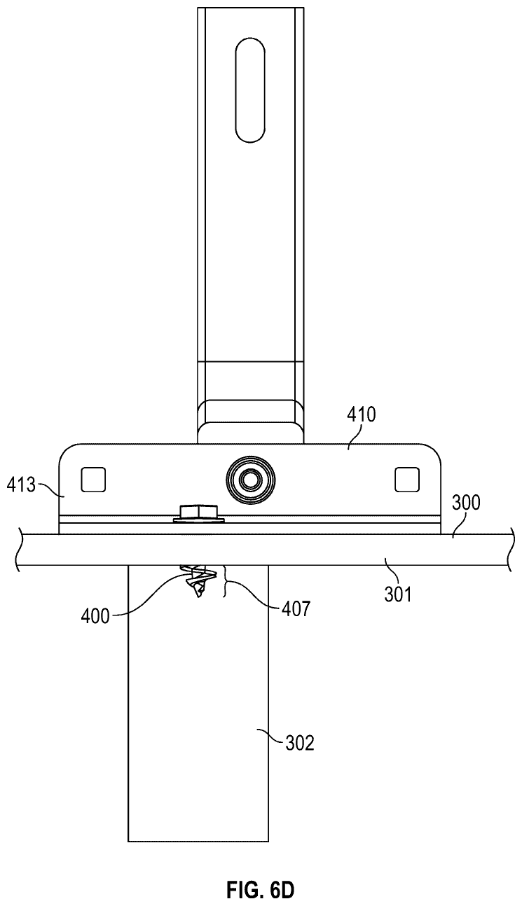

FIGS. 6A-D depict an isometric view, a side view, and end view of an exemplary hook mount 410 fastened to an installation surface 300 having one or more substrates using two deck fasteners 400. As depicted, the two deck fasteners 400 are installed in adjacent mount apertures 402 in the mount plate 413, although the deck fasteners 400 may alternatively be installed in different configurations, such as in opposing corners of the mount plate 413.

As shown in FIGS. 6B and 6C, a deck fastener 400 may fully protrude through the first substrate 301, with the tapered end 407 or cutting edge 409 protruding through the lower surface of the first substrate 301 when the deck fastener 400 is installed through the hook mount 410 and into the first substrate 301. The shank 103 and/or the deck thread 101 may have a constant diameter through the thickness of the first substrate 301, then transition to a tapered fastener tip 107 below the bottom surface of the first substrate 301. Alternatively, the shank 103 and/or deck thread 101 may reduce in diameter along the length of the deck fastener shank 403 towards the tapered end 407 through the thickness of the first substrate 301, then transition to a sharper tapered end 407 below the bottom surface of the first substrate 301.

As shown in FIG. 6D, the hook mount 410 is positioned on an installation surface 300 wherein one or more deck fasteners 400 are installed over and into the second substrate 302. The deck fastener 400 may be configured such that its tapered end 407 cuts, drills, taps, or otherwise screws into the second substrate 302 without splitting or severely damaging the second substrate 302. In this configuration, the deck fastener shank 403 may be tapered or cylindrical along its length substantially through the thickness of the first substrate 301, and then the deck fastener shank 403 and the deck fastener thread 401 may taper in diameter below the bottom surface of the first substrate 301 into second substrate 302 in order to reduce any or minimize damage to the second substrate 302.

While the dimensions of the substrates can vary, examples of thickness of the first substrate 301 are 7/16, ½, ⅝, ¾, or 1 inch thick, and examples of thicknesses of the second substrate 302 are 1.5 inches wide by 3.5 or 5.5 inches tall, such as a 2×4 or 2×6 commonly used in wood beams. In some examples, a composition shingle or an asphalt shingle may be disposed on top of the first substrate 301. In other examples, one or more sheets of roofing paper, such as tar paper, may be disposed on top of the first substrate 301.

In some example embodiments, the mount 303 and hook mount 410 are configured to secure solar energy modules to an installation surface 300. In some examples, the installation surface 300 is a building rooftop, and in other examples the installation surface 300 may be a foundation on the ground. In some cases, an aluminum or steel rail, or beam, is attached to mount 303 and hook mount 410, and then a solar energy module is secured to one or more rails using one or more clamps. In other examples, the solar energy module may be secured directly to the mount 303 or hook mount 410 using one or more clamps or fasteners. The solar energy panels can be solar photovoltaic panels with a power rating of 300 to 1000 watts each.

FIGS. 7A-B depict a side view and a cross-sectional view of another exemplary fastener 500. This fastener 500, similar to several of the others discussed above, has a shank with a longitudinal axis 501, an upper portion 502 and a lower portion 503, joined at a transition point 504. The upper portion 502 tapers in diameter from the head 505 of the fastener down to the transition point 504, and the threads are in three sizes, a primary thread 506 on the lower portion 503 of the shaft, a secondary thread 507, also on the lower portion 503 of the shaft and alternating with the primary thread, and a tertiary thread 508 on the upper portion 502 of the shank. Of the three thread sizes, the primary thread 506 has the smallest diameter, the tertiary thread 508 has the largest diameter, and the secondary thread 507 has a diameter intermediate to those of the primary and tertiary threads. The dimensions of these features can vary, but as an example, the taper of the upper portion 502 of the shank may form an angle of about 1 degree to about 5 degrees relative to the longitudinal axis 501 of the fastener over an upper portion length of about one inch. Alternatively, the diameter of the upper portion may taper from about 6 mm at the shank upper end to about 5 mm at the transition point 504. As for the threads, the primary thread 506 may have a diameter of about 5.9 mm, the secondary thread 507 may have a diameter of about 6.8 mm, and the tertiary thread 508 may have a diameter of about 8.5 mm.

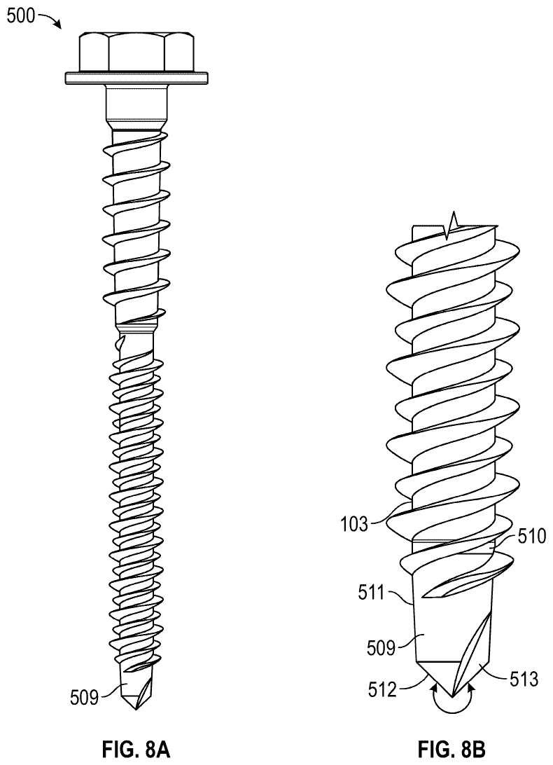

FIG. 8A depicts a side view of an alternative exemplary embodiment of a fastener 500 with a distal end. FIG. 8B depicts a close-up view of the distal end of an exemplary fastener 500. In this example embodiment, fastener 500 has a spade tip 509 instead of the previously depicted fastener tip 107. In some examples, spade tip 509 may have a tip shank 511 with a diameter equal to or less than the diameter of shank 103. In some examples, tip transition region 510 can either be a point along the longitudinal axis 116 forming an abrupt transition, or a frustoconical section of the shank as shown in FIG. 8B. In some examples, spade surface 512 may be more blunt than previously depicted fastener tip 107. For example, the adjacent faces forming the point are at an angle between 160 to 90 degrees. In some examples, one or more spade cutting edges 513 may be disposed axially around spade tip 509, and configured to cut through material such as wood, aluminum, steel, or a polymer.

What is claimed is:

1. A threaded fastener for securing a plate to a layered substrate, the threaded fastener comprising:
a head; and
a shank having a longitudinal axis between a first end and a second end, wherein the shank is connected to the head at the second end, the shank comprising:
a pointed terminus at the first end;
a first portion between the first end and a transition region, wherein the first portion includes a first thread having a first thread profile that encircles the first portion; and
a second portion between the transition region and the second end, wherein the transition region resides between the first portion and the second portion, and wherein the second portion includes a second thread having a second thread profile that encircles the second portion.

2. The threaded fastener of claim 1, wherein a first shank diameter of the first portion is smaller than a second shank diameter of the second shank diameter.

3. The threaded fastener of claim 2, wherein the transition region is a frustoconical section of the shank tapering from the second shank diameter to the first shank diameter.

4. The threaded fastener of claim 1, wherein a first thread major diameter of the first thread profile is smaller than a second thread major diameter of the second thread profile.

5. The threaded fastener of claim 1, wherein a first shank diameter of the first portion is smaller than a second shank diameter of the second portion, and wherein a first thread major diameter of the first thread profile is smaller than a second thread major diameter of the second thread profile.

6. The threaded fastener of claim 5, wherein a ratio between the first thread major diameter and the first shank diameter is between 1.6:1.0 to 1.8:1.0.

7. The threaded fastener of claim 5, wherein a ratio between the second thread major diameter and the second shank diameter is between 1.3:1.0 to 1.6:1.0.

8. The threaded fastener of claim 5, wherein a ratio between the second thread major diameter and the first thread major diameter is between 1.1:1.0 to 1.4:1.0.

9. The threaded fastener of claim 1, wherein the first portion further includes a cutting edge adjacent to the first end.

10. The threaded fastener of claim 1, wherein the first thread and the second thread follow a substantially similar helical path around the longitudinal axis of the shank.

11. The threaded fastener of claim 1, wherein the first thread and the second thread are separated by a gap at the transition region.

12. The threaded fastener of claim 1, further comprising a head flange between the head and the second portion.

13. The threaded fastener of claim 12, wherein the head flange is circular and symmetrically disposed around the longitudinal axis of the shank, the head flange having a flange diameter that exceeds each of a width of the head, a first thread major diameter of the first thread profile, and a second thread major diameter of the second thread profile.

14. The threaded fastener of claim 1, further comprising a third thread having a third thread profile that encircles the first portion, wherein a path of the third thread alternates with a path of the first thread along the longitudinal axis of the shank.

15. The threaded fastener of claim 14, wherein a third thread major diameter of the third thread profile is less than a first thread major diameter of the first thread profile.

16. The threaded fastener of claim 1, wherein the shank is made of a steel material that is coated with an anti-corrosion coating.

17. The threaded fastener of claim 1, wherein the shank is made of a stainless-steel material.

18. The threaded fastener of claim 1, wherein the second portion further includes a sleeve adapted to fit over the shank along the second portion.

19. The threaded fastener of claim 18, wherein the first thread further encircles the shank along the second portion, and wherein the sleeve has a hollow interior threaded to mate with the first thread.

20. The threaded fastener of claim 19, wherein a diameter of the shank along the second portion is identical to a diameter of the shank along the first portion, wherein the first thread is continuous along the first portion and the second portion, and wherein the first thread profile of the first thread remains identical along the first portion and the second portion.

21. The threaded fastener of claim 19, further comprising:
a head flange disposed between the head and the second portion; and
a sleeve flange on the sleeve, wherein the sleeve flange contacts the head flange when the sleeve is installed over the second portion of the shank.

22. The threaded fastener of claim 21, further comprising:
one or more head flange serrations on the head flange; and
one or more sleeve flange serrations on the sleeve flange, the sleeve flange serrations arranged to oppose and mate with the head flange serrations when the sleeve is installed over the second portion of the shank, wherein mated sleeve flange serrations and head flange serrations prevent rotation of the sleeve relative to the shank.

23. A method for securing a plate to a layered substrate, the method comprising:
positioning the plate on the layered substrate that includes at least a first layer and a second layer, wherein the plate is positioned adjacent to the second layer so that the second layer is between the first layer and the plate;
aligning a threaded fastener with an aperture in the plate, the threaded fastener including a shank having a first thread and a second thread; and
installing the threaded fastener through the aperture and into the layered substrate such that a first portion of the shank corresponding to the first thread extends into the first layer and a second portion of the shank corresponding to the second thread extends into the second layer.

24. The method of claim 23, wherein a first material hardness of the first layer is greater than a second material hardness of the second layer.

25. The method of claim 23, wherein a first thread major diameter of the first thread is smaller than a second thread major diameter of the second thread.

26. The method of claim 23, further comprising installing a second threaded fastener in a second aperture of the plate such that a second thread of the second threaded fastener extends into the second layer of the layered substrate but a first thread of the second fastener does not extend into the layered substrate.

27. The method of claim 23, wherein a ratio between a second thread major diameter and a first thread major diameter is between 1.1:1.0 to 1.4:1.0.

28. A threaded fastener for securing a plate to a substrate, the threaded fastener comprising:
a head;
a shank having a longitudinal axis between a first end and a second end, wherein the shank is connected to the head at the second end, the shank comprising:
a pointed terminus at the first end, and
a thread that encircles the shank along the longitudinal axis; and
a part line along the longitudinal axis of the shank, wherein the part line corresponds to a casting method used to form the threaded fastener.

29. The threaded fastener of claim 28, wherein the shank tapers along the longitudinal axis from the second end to the first end.

30. The threaded fastener of claim 28, wherein the head has an upper surface that is sloped downward in opposite directions from the part line.
